(19) United States
(12) Patent Application Publication
(10) Pub. No.: US 2011/0268362 A1
(43) Pub. Date: Nov. 3, 2011

(54) PROBE AND IMAGE RECONSTRUCTION METHOD USING PROBE

(76) Inventors: Tadamasa Toma, Osaka (JP); Satoshi Kondo, Kyoto (JP); Sheng Mei Shen, Singapore (SG); Zhongyang Huang, Singapore (SG); Jun Cheng, Singapore (SG)

(21) Appl. No.: 13/142,962

(22) PCT Filed: Sep. 1, 2010
(86) PCT No.: PCT/JP2010/005376

§ 371 Date: Jun. 30, 2011

(30) Foreign Application Priority Data
Sep. 4, 2009 (JP) 2009-205252

(51) Int. Cl. G06K 9/46; G01J 5/32

(52) U.S. Cl. 382/195; 250/349

(57) ABSTRACT

Provided is a probe capable of effectively performing NIR imaging by optimally arranging input channels and detection channels, and an image reconstruction method using the probe. The probe (10) according to the present invention performs NIR imaging on a region of interest (16) that is an imaging target, and includes a probe body (11) in which the input channels and the detection channels are arranged, and the probe body includes: first input channels (131) arranged in the upper area (19); first detection channels (141) arranged in the lower area (20); second input channels (132) arranged in the left area (17); and second detection channels (141) arranged in the right area (18).

### TECHNICAL FIELD

The present invention relates to a probe and an image reconstruction method using the probe, and particularly to a probe using near infrared (NIR) imaging and an image reconstruction method using the probe. Furthermore, the present invention relates to, for example, a probe using both ultrasound imaging and NIR imaging.

### BACKGROUND ART

Conventionally, there have been medical imaging modalities for diagnosing, such as ultrasound imaging and NIR imaging.

Ultrasound imaging is now a widely used as a medical imaging modality. It has been used extensively for medical purposes such as breast examinations. Ultrasound imaging can detect lesions that are a few millimeters in size; however, it cannot differentiate benign tumors from malignant ones. Thus, measurements obtained in ultrasound imaging cannot identify lesions, which further leads to a large number of unnecessary biopsies.

NIR imaging makes use of light absorption and scattering in body tissue. NIR imaging offers the specialty of functional imaging, which makes it possible for NIR imaging to differentiate benign tumors from malignant ones. The fundamental idea of NIR imaging is that the internal distribution of optical parameters such as absorption and scattering coefficients can be reconstructed based on a set of measurements of transmitted and/or reflected light from points on the boundary of an object. In other words, these measurements carry the information of optical parameters in body tissue, and the reconstruction is to retrieve the information in body tissue. The reconstruction of optical parameters based on the measurements has an inverse problem, which is extremely ill-posed. Thus, it is difficult to uniquely solve the problem. As a result, NIR imaging has a relative low resolution.

Here, methods of combining NIR imaging with ultrasound imaging have been suggested (PTL 1 and PTL 2). Each of the methods is to obtain prior information of internal optical distributions in body tissue, using ultrasound imaging, reduce the region of interest (ROI) based on ultrasound imaging results, and then perform NIR imaging on the ROI. Thereby, the inverse problem is less ill-posed, and a finer resolution is achievable.

### CITATION LIST

### Patent Literature

[PTL 1] U.S. Pat. No. 6,264,610
[PTL 2] US Patent Application No. 2004/0215072

### SUMMARY OF INVENTION

### Technical Problem

As the measurements obtained in NIR imaging or ultrasound imaging carry the information of absorption and scattering parameters in body tissue where the light gets absorbed, scattered and/or reflected, an area where light passes (light path) is important.

In NIR imaging, light is irradiated from an optical input channel (light source), interacted with the body tissue, and detected by a detection channel (detector). The optical input channels and the detection channels are placed on a probe, and each of the optical input channels and the detection channels is connected to a light source and a light detector provided outside of the probe, through optical fibers. Examples of the probes include a scanner type in which the surface of human body is scanned and a dome type in which an entire object such as breast is covered.

Since the light path of light that passes through body tissue is determined by the arrangement of the optical input channels and the detection channels, the arrangement is important in terms of the performance of NIR imaging. Due to the consideration of cost effective, the limited space of probe body and usability of especially for a scanner-type probe, efficient arrangements of the optical input channels and the detection channels with large light path coverage of the ROI are beneficial to make the inverse problem less ill-posed. It is necessary to reduce the redundancy among measurements.

However, the conventional methods for measurement according to PTL 1 and PTL 2 heuristically adjust measurements while confirming results of reconstructed images. Thus, there are problems that the measurement time and the processing time for reconstructing images using NIR imaging increase due to the presence of unnecessary optical input channels and detection channels and that the size of the probe body accordingly increases. In other words, since some of the conventional methods do not cover any portion of the ultrasound imaging ROI, the arrangements of optical input channels and detection channels are not efficient and many measurements are not useful. Moreover, the big size of the probe body is not appropriate for relatively small breast from Asian women.

For a practical application of tumor imaging, it would be beneficial to change the ROI of NIR imaging to focus on different depths depending on tumor locations. However, there is another problem that the NIR imaging ROI cannot be adaptively changed in the conventional methods for measurement.

The present invention has been conceived in view of these problems, and has an object of providing a probe in which optical input channels and detection channels are optimally arranged and which can effectively perform NIR imaging, and an image reconstruction method using the probe.

### Solution to Problem

In order to solve the problems, the probe according to an aspect of the present invention is a probe that performs near infrared (NIR) imaging on a region of interest that is an imaging target, and includes a probe body in which input channels and detection channels are arranged, wherein an area of the probe body corresponding to the region of interest is a specific area, and in a planar view of the probe body, areas to the left, the right, the upper, the lower, the upper right, the lower right, the lower left, and the upper left of the specific area are defined as a left area, a right area, an upper area, a lower area, an upper right area, a lower right area, a lower left area, and an upper left area, respectively, and the probe body includes: one or more first input channels arranged in only one of the upper area and the lower area; one or more first detection channels arranged in only the other one of the upper area and the lower area; one or more second input channels arranged in at least one of the left area, the right area, the upper right area, the lower right area, the lower left area, and the upper left area; and one or more second detection channels arranged in an area opposite to the one of the left area, the right area, the upper right area, the lower right area, the lower left area, and the upper left area in which the second input channels are arranged with the specific area disposed in between.

Preferably, in the probe according to an aspect of the present invention, each of (i) a light path from each of the first input channels to a corresponding one of the first detection channels and (ii) a light path from each of the second input channels to a corresponding one of the second detection channels overlaps with the region of interest by more than a certain degree.

Preferably, in the probe according to an aspect of the present invention, the first input channels and the first detection channels include respective channels.

Preferably, in the probe according to an aspect of the present invention, the first input channels and the first detection channels are arranged in respective lines, and each of the lines includes the first input channels and the first detection channels.

Preferably, in the probe according to an aspect of the present invention, a light path from the first input channel arranged in a first line to the first detection channel arranged in a direction of the first line overlaps with a light path from the first input channel arranged in a second line adjacent to the first line to the first detection channel arranged in a direction of the second line.

Preferably, in the probe according to an aspect of the present invention, first light paths from the first input channels to the first detection channels overlap and intersect with second light paths from the second input channels to the second detection channels.

Preferably, in the probe according to an aspect of the present invention, the first light paths are approximately orthogonal to the second light paths.

Preferably, in the probe according to an aspect of the present invention, an ultrasound transducer in the specific area which transmits ultrasound waves and receives ultrasound echoes, wherein the region of interest is determined based on an imaging area of the ultrasound transducer.

Preferably, the probe according to an aspect of the present invention further includes a movable part that allows positions of at least one of the first input channels, the first detection channels, the second input channels, and the second detection channels to be changed.

Preferably, the probe according to an aspect of the present invention further includes an incidence angle changing mechanism that allows, to be changed, an angle of light incident from one of the first input channels and the second input channels to the region of interest, or an angle of light incident when one of the first detection channels and the second detection channels receive light.

Furthermore, the image reconstruction method according to an aspect of the present invention is an image reconstruction method of acquiring optical data of tissue and reconstructing an image of the tissue by putting the aforementioned probe on a surface of the tissue and performing NIR imaging on the tissue, and the image reconstruction method includes: determining a region of interest that is a target for the NIR imaging; illuminating the region of interest by at least one input channel on the probe; detecting, by at least one detection channel, light that is illuminated by the input channel and propagates through the tissue; and reconstructing optical characteristics in the region of interest by using the detected light.

### Advantageous Effects of Invention

The probe and the image reconstruction method according to the present invention enable the arrangement of optical input channels and detection channels minimum required for the NIR imaging. Thus, the measuring time and the processing time for reconstructing images in the NIR imaging can be reduced. Furthermore, since there is no useless optical input channel or detection channel for the ROI, the probe body will not be upsized.

Furthermore, the distance between an optical input channel and a detection channel can be changed by moving the positions of the optical input channel and the detection channel, in the probe according to the present invention. Thereby, since it is possible to adjust the position of the light path in the depth direction in the NIR imaging and focus on different depths, it is possible to perform desired NIR imaging on a specific area of the ROI without using many optical input channels and detection channels.

### BRIEF DESCRIPTION OF DRAWINGS

FIG. 1A illustrates an external perspective view of a probe according to Embodiment 1 in the present invention.

FIG. 1B illustrates a region of interest in a probe according to Embodiment 1 in the present invention.

FIG. 2A is a plain view that illustrates the basic concept of a light path from one optical input channel to one detection channel in a probe according to Embodiment 1 in the present invention.

FIG. 2B is a cross-section view that illustrates the basic concept of a light path from one optical input channel to one detection channel in a probe according to Embodiment 1 in the present to invention.

FIG. 2C is a cross-section view that illustrates the basic concept of a light path when a distance between an optical input channel and a detection channel is changed in a probe according to Embodiment 1 in the present invention.

FIG. 3 is a flowchart for computing a light path from an optical input channel to a detection channel.

FIG. 4A illustrates relationship between the most probable light path and an ROI, in the arrangement of FIG. 2A.

FIG. 4B is a cross-sectional view illustrating relationship between an ROI and a light path in the arrangement of an optical input channel and a detection channel in FIGS. 2A and 4A.

FIG. 5A illustrates an arrangement of the second input channel and the second detection channel in the probe of FIG. 1A.

FIG. 5B is a cross-sectional view illustrating relationship between an ROI and a light path in the arrangement of the second input channel and the second detection channel in FIG. 5A.

FIG. 6 illustrates that the second input channel and the second detection channel are arranged in respective lines.

FIG. 7 illustrates an arrangement of the first input channels and the first detection channels in the probe of FIG. 1A.

FIG. 8A illustrates all light paths when only the first input channels are arranged in the upper areas and only the first detection channels are arranged in the lower areas.

FIG. 8B illustrates all light paths when one optical input channel and two detection channels are arranged in the upper area and two optical input channels and one detection channel are arranged in the lower area.

FIG. 9 is a flowchart indicating the main procedure for designing a probe according to Embodiment 1 in the present invention.

FIG. 10A illustrates an external perspective view of a probe according to Embodiment 2 in the present invention.

FIG. 10B illustrates a state where two light paths cross with each other in a probe according to Embodiment 2 in the present invention.

FIG. 10C illustrates a state where two light paths cross with each other in a probe according to Embodiment 2 in the present invention (a cross-section view of the probe along the A-A′ line in FIG. 10A).

FIG. 11A illustrates an external perspective view of a probe according to Embodiment 3 in the present invention.

FIG. 11B illustrates a state where two light paths cross with each other in a probe according to Embodiment 3 in the present invention.

FIG. 11C illustrates a state where two light paths cross with each other in a probe according to Embodiment 3 in the present invention (a cross-section view of the probe along the A-A′ line in FIG. 11A)

FIG. 12 illustrates an external perspective view of a probe according to Embodiment 4 in the present invention.

FIG. 13A illustrates an external perspective view of a probe according to Embodiment 4 in the present invention.

FIG. 13B illustrates an external perspective view of a top movable part or a bottom movable part of a probe according to Embodiment 4 in the present invention.

FIG. 13C illustrates an external perspective view of a holder of a probe according to Embodiment 4 in the present invention.

FIG. 14 illustrates an external perspective view of a probe according to Embodiment 5 in the present invention.

FIG. 15A illustrates a probe according to Embodiment 6 in the present invention (when an ROI is a shallow part).

FIG. 15B illustrates a probe according to Embodiment 6 in the present invention (when an ROI is a deep part).

FIG. 16 is a block diagram illustrating a configuration of an NIR imaging system according to Embodiment 7 in the present invention.

### DESCRIPTION OF EMBODIMENTS

Hereinafter, a probe, an optical measurement method using the to probe, an image reconstruction method using the probe, and an NIR imaging system using the probe will be described with reference to drawings according to Embodiments.

The probe according to Embodiments to be described hereinafter is a probe for NIR imaging that propagates through internal body tissue and measures light to be transmitted to the surface of the tissue. Embodiments mainly describe the arrangement of optical input channels and detection channels included in the probe. The design method of the arrangement and an NIR imaging system will be described later.

In each of the drawings, X, Y, and Z axes are orthogonal to each other, and the X-Y plane of the X and Y axes is approximately parallel to the measurement surface of the probe body. Furthermore, the Z axis represents a depth direction of body tissue to be imaged.

### Embodiment 1

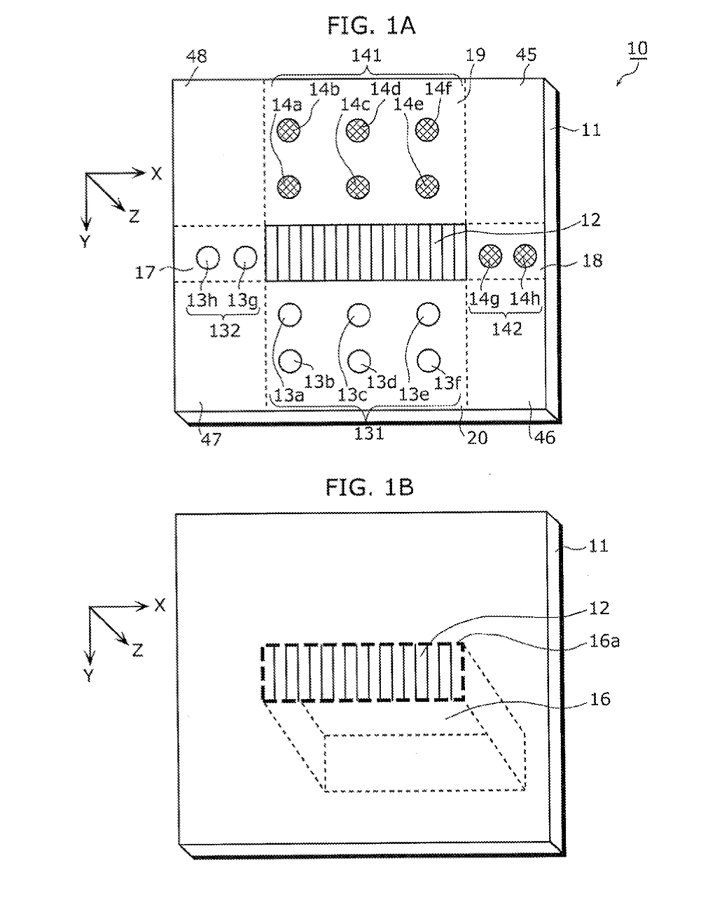

First, a probe according to Embodiment 1 in the present invention will be described with reference to FIGS. 1A and 1B. FIG. 1A illustrates an external perspective view of the probe according to Embodiment 1 in the present invention. Furthermore, FIG. 1B illustrates an ROI in the probe according to Embodiment 1 in the present invention.

As illustrated in FIG. 1A, a probe 10 according to Embodiment 1 is a probe for performing NIR imaging on an ROI (observation area) in tissue to be imaged. The probe 10 includes a probe body 11, optical input channels 13a to 13h, and detection channels 14a to 14h. Furthermore, the probe 10 according to Embodiment 1 includes an ultrasound transducer 12.

The probe body 11 has a rectangular measurement surface, on which the optical input channels 13a to 13h, the detection channels 14a to 14h, and the ultrasound transducer 12 are arranged. Here, the measurement surface of the probe body 11 is approximately parallel to the X-Y plane according to Embodiment 1.

Each of the optical input channels 13a to 13h illuminates body tissue (underlying tissue) to be measured under the probe body 11 (on the measurement surface), and is a light source on the probe 10. The light entering body tissue from each of the optical input channels 13a to 13h is interacted with the body tissue through absorption and scattering therein.

The light entering underlying tissue from each of the optical input channels 13a to 13h travels in all directions. In other words, the light entering from each of the optical input channels 13a to 13h hemispherical-concentrically travels from the measurement surface to underlying tissue. Furthermore, according to Embodiment 1, each of the optical input channels 13a to 13h is a light source fiber, and is connected to a light source provided outside of the probe 10 through an optical fiber. Examples of the light source provided outside include a semiconductor laser.

Furthermore, each of the detection channels 14a to 14h receives light transmitted in an area in body tissue from a corresponding one of the optical input channels 13a to 13h, and is a light detector on the probe 10. Each of the detection channels 14a to 14h is arranged to receive light from a corresponding one of the optical input channels 13a to 13h.

Each of the detection channels 14a to 14h is a detector fiber, and is connected to a photoelectric conversion device provided outside of the probe 10 through an optical fiber. Here, each of the detection channels 14a to 14h may have a photoelectric conversion function. In this case, the detection channels 14a to 14h are connected to not an optical fiber but an electrical signal line to transmit a resulting electrical signal outside.

Furthermore, each of the detection channels 14a to 14h can detect light selectively from the optical input channels 13a to 13h. In other words, one detection channel can detect light from all of the optical input channels, and continuously detect light from each of the optical input channels in different times.

The ultrasound transducer 12 transmits ultrasound waves to body tissue and receives the ultrasound echoes reflected from the body tissue. The ultrasound transducer 12 is placed at the center of the probe body 11. The ultrasound transducer 12 may include piezoelectric elements.

Furthermore, an imaging area obtained through ultrasound imaging by the ultrasound transducer 12 can be determined as a region of interest (ROI). The ROI is not limited to the imaging area obtained through the ultrasound imaging but sometimes an imaging area obtained through NIR imaging, which is an observation target for imaging.

In other words, a region of interest (ROI) 16 according to Embodiment 1 is an area to be imaged using NIR imaging or ultrasound imaging, and is a three-dimensional area in a lower side (tissue side) of the probe body 11 as illustrated in FIG. 1B. Assuming that a two-dimensional area obtained by projecting the ROI 16 in a two-dimensional area on the X-Y plane is a specific area 16a of the probe body 11, the specific area 16a of the probe body 11 matches an area in which the ultrasound transducer 12 is placed according to Embodiment 1. In FIG. 1B, the specific area 16a is enclosed by a thick broken line.

In the probe 10 according to Embodiment 1, the area in which the ultrasound transducer 12 is placed, that is, a proximate area proximate to the specific area 16a that is a reference area is defined as follows. In other words, as illustrated in FIG. 1A, with respect to the rectangular ultrasound transducer 12 or the specific area 16a that in is the reference area, the area to the left of the ultrasound transducer 12 that is proximate to the left part of the ultrasound transducer 12 is a left area 17, the area to the right of the ultrasound transducer 12 that is proximate to the right part of the ultrasound transducer 12 is a right area 18, the area to the upper of the ultrasound transducer 12 that is proximate to the top of the ultrasound transducer 12 is an upper area 19, and the area to the lower of the ultrasound transducer 12 that is proximate to the bottom of the ultrasound transducer 12 is a lower area 20.

Furthermore, the area to the upper right of the ultrasound transducer 12 that is to the right of the upper area 19 and above the right area 18 is an upper right area 45, the area to the lower right of the ultrasound transducer 12 that is to the right of the lower area 20 and below the right area 18 is a lower right area 46, the area to the lower left of the ultrasound transducer 12 that is to the left of the lower area 20 and below the left area 17 is a lower left area 47, and the area to the upper left of the ultrasound transducer 12 that is to the left of the upper area 19 and above the left area 17 is an upper left area 48.

According to Embodiment 1, the left area 17, the right area 18, the upper area 19, the lower area 20, the upper right area 45, lower right area 46, the lower left area 47, and the upper left area 48 can be used as areas in which the optical input channels and the detection channels are placed.

In Embodiment 1, the left area 17, the right area 18, the upper area 19, the lower area 20, the upper right area 45, lower right area 46, the lower left area 47, and the upper left area 48 are defined, but not limited to, with reference to the rectangular area where the ultrasound transducer 12 is placed.

For example, without the ultrasound transducer 12, each area can be defined based on the specific area 16a corresponding to the ROI 16 in the same manner as above. Furthermore, the area where the ultrasound transducer 12 is placed or the specific area 16a that is the reference area is not necessarily rectangular. In this case, the area has only to be defined in a two-dimensional area after the reference area is determined based on the largest length in the X axis direction and the largest length in the Y axis direction. In other words, the rectangular area determined based on the largest length in the X axis direction and the largest length in the Y axis direction in the two-dimensional area is determined as the reference area. Then, 8 areas to the left, the right, the upper, the lower, the upper right, the lower right, the lower left, and the upper left of the reference area changed into the rectangular area may be defined as a left area, a right area, an upper area, a lower area, an upper right area, a lower right area, a lower left area, and an upper left area, respectively. In other words, assuming the two-dimensional area as the rectangular reference area, the 8 areas with respect to the reference area can be defined.

The inverse problem of image reconstruction is less ill-posed by acquiring measurements that carry more information from the right points on the boundary of the object body tissue. Thus, the arrangement of optical input channels and detection channels is important. Hereinafter, the arrangement of optical input channels and detection channels will be described in detail.

In the following, it is explained based on the case where the ultrasound transducer 12 is present, but the method in Embodiment 1 can be applied even if the ultrasound transducer 12 is not present. In other words, the probe 10 does not always have to include the ultrasound transducer 12. The ultrasound transducer 12 is mainly used for determining an ROI in Embodiment 1. When the ultrasound transducer 12 is not present, the ROI can be determined by some other means (sensors or others) different from the optical input channels 13a to 13h or the detection channels 14a to 14h, or the ROI can be predetermined. Furthermore, for example, an x-ray probe, a magnetic probe, or other optical probes can be arranged in the area where the ultrasound transducer 12 is arranged. Alternatively, it is also possible to arrange nothing in the area where the ultrasound transducer 12 is arranged.

As illustrated in FIG. 1A, the probe 10 according to Embodiment 1 also includes a first input channel 131 arranged in the lower area 20, and a first detection channel 141 arranged in the upper area 19.

The first input channel 131 according to Embodiment includes six of the optical input channels 13a to 13f arranged in 2 rows and 3 columns of a matrix. Furthermore, the first detection channel 141 includes six of the detection channels 14a to 14f arranged in 2 rows and 3 columns of a matrix. The optical input channels 13a to 13f are arranged horizontal to the detection channels 14a to 14f.

Although the first input channel 131 is arranged in the lower area 20 and the first detection channel 141 is arranged in the upper area 19 according to Embodiment 1, the first input channel 131 may be arranged in the upper area 19 and the first detection channel 141 may be arranged in the lower area 20. However, each of the first input channel 131 and the first detection channel 141 is collectively arranged in only one of the upper area 19 and the lower area 20. In other words, the first detection channel 141 is not arranged in an area where the first input channel 131 is arranged, and conversely, the first input channel 131 is not arranged in an area where the first detection channel 141 is arranged.

The probe 10 according to Embodiment 1 also includes a second input channel 132 arranged in the left area 17, and a second detection channel 142 arranged in the right area 18.

The second input channel 132 according to Embodiment 1 includes two of the optical input channels 13g and 13h that are horizontally arranged in one line. Furthermore, the second detection channel 142 includes two of the detection channels 14g and 14h that are horizontally arranged in one line. The optical input channels 13g and 13h are arranged vertical to the detection channels 14g and 14h.

Each of the detection channels 14a to 14h can receive light from all the optical input channels 13a to 13h, regardless of where the optical input channels 13a to 13h are arranged.

Here, in order to reduce the influence of the ill-posed inverse problem of image reconstruction, it is preferable to arrange more optical input channels and detection channels to get more measurements.

However, due to practical reasons such as limited space and the cost considerations, the probe body 11 can only accommodate a limited number of optical input channels and detection channels. Assuming a total of N optical input channels and M detection channels, the maximum number of measurements can be represented by N×M. In order to have all the N×M measurements useful for the image reconstruction, all the N optical input channels and M detection channels are preferred to be placed such that the light path from each of the N optical input channels to a corresponding one of the M detection channels passes through at least a portion of the ROI for imaging.

In the application of ultrasound imaging combined with NIR imaging, the NIR imaging ROI is normally set to be the same as the ultrasound imaging ROI. When both of the ultrasound imaging and the NIR imaging are used, the result of the ultrasound imaging is obtained first. Then, the ultrasound images can be used as prior information for the NIR image reconstruction to set the same ROI. For example, as a tumor, if any, is first detected by the ultrasound imaging, the tumor as well as its surrounding area are more of our interest. Then, we have the NIR focus on the tumor and its proximate for finer resolutions. In both cases, the ROI to be reconstructed by the NIR imaging should be completely covered by the light path. As a result, a good arrangement of optical input channels and detection channels is important and necessary.

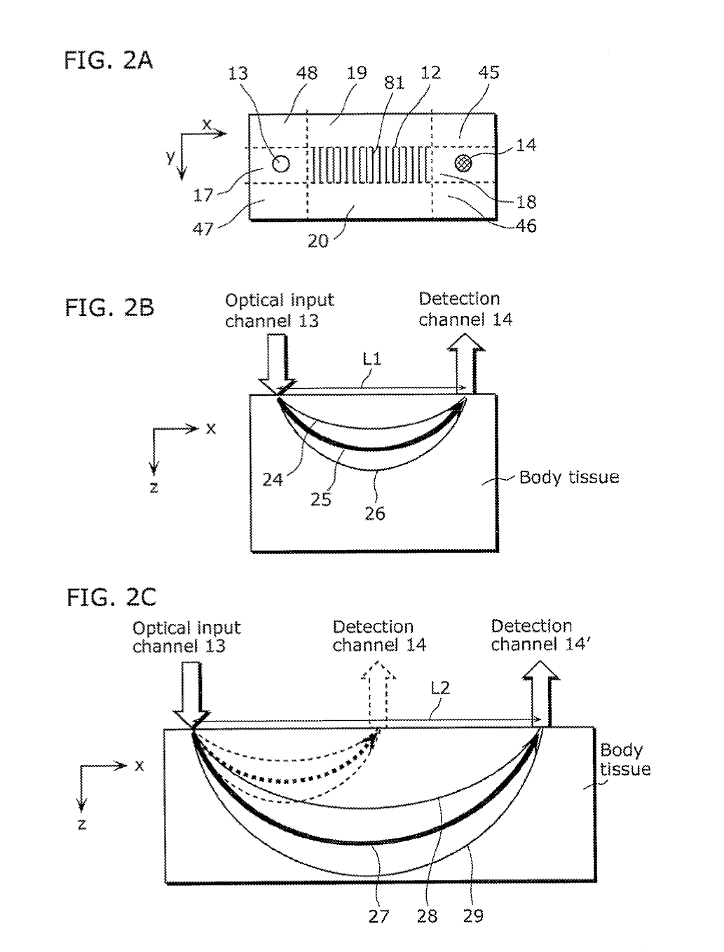

Hereinafter, a light path from an optical input channel to a detection channel will be described with reference to FIGS. 2A to 2C. FIGS. 2A to 2C schematically illustrate the basic concept of a light path from one optical input channel to one detection channel in a probe according to Embodiment 1. FIG. 2A is the plain view, and FIGS. 2B and 2C are the cross-section views. Eight areas adjacent to the ultrasound transducer 12 in FIG. 2A are obtained by dividing the probe into eight areas as in the same method as FIG. 1A, and are denoted by the same numerals in FIG. 1A.

The case where an optical input channel 13 is arranged in the left area 17, a detection channel 14 is arranged in the right area 18, and the optical input channel 13 and the detection channel 14 are arranged at a separation L1 will be described with reference to FIG. 2A. The light path of light entering from body tissue to the optical input channel 13 and detected by the detection channel 14 follows a banana shape, which is enclosed by banana-shape boundaries 24 and 26 in the cross section of a light transmission area. The light transmission area is an area with sensitivity to changes in absorption coefficients over a threshold. The sensitivity can be expressed by a probability of light propagation. A center line 25 illustrated by a thick line is the most probable light path in the light transmission area of banana-shape light. The probability that light propagates within the light transmission area enclosed by the boundaries 24 and 26 decreases from the middle of the center line 25 upward to the boundary 24, or from the center line 25 downward to the boundary 26. The probability of light propagation outside of the light transmission area of the banana-shape light is ignorable. As described above, light propagates through a predetermined area along a banana-shape arc between an optical input channel and a detection channel. Here, the light transmission area is an area with sensitivity to changes in absorption coefficients over a threshold.

Furthermore, as illustrated in FIG. 2C, when the detection channel 14 is replaced with a detection channel 14′, that is, when a separation L2 between the optical input channel 13 and the detection channel 14′ is longer than the separation L1 in FIG. 2B, the light path covers a deeper area in body tissue. The light path is also a light transmission area of the banana-shape light including a center line 27 illustrated as the most probable light path by a thick line and enclosed by boundaries 28 and 29.

Thus, light paths are different from each other, depending on a distance between an optical input channel and a detection channel and the positions. In other words, the light transmission area varies depending on the arrangement of the optical input channel and the detection channel. As the separation between the optical input channel and the detection channel is longer, light passes through a deeper area in body tissue. Accordingly, it is necessary to appropriately set the separation between the optical input channel and the detection channel in order for the light path to cover the ROI.

Furthermore, since the sensitivity for detecting a tumor depends on the amount of light that passes through an area where the tumor exists, the arrangement of the optical input channel and the detection channel is an important factor that determines the performance on resolution.

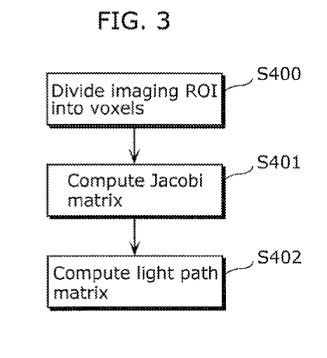

Such light paths and light path boundaries are determined by the sensitivity described by a Jacobi matrix. In other words, for an optical input channel (source S) and a detection channel (detector D), a light path from the optical input channel (source S) to the detection channel (detector D) is computed following the steps in FIG. 3. FIG. 3 is a flowchart for computing the light path from the optical input channel to the detection channel.

As illustrated in FIG. 3, in step S400, an ROI to be imaged (imaging ROI) is divided into voxels.

Next in step 401, a Jacobi matrix is computed for all voxels in the imaging ROI. The Jacobi matrix defines relationship between perturbation of optical parameters and change in measurements as expressed by Equation (1).

$$\begin{matrix}[ Math . 1 ] & \\ J ( x , y , z ) - \frac{\partial {m}_{SD}}{\partial {μ}_{x , y , z}} & ( 1 )\end{matrix}$$

Here, m_{SD} denotes the measurement from the detection channel (detector D) when S denotes the optical input channel (source), and μ_{x,y,z} denotes the optical parameters for the voxel at (x, y, z). Each element in the matrix corresponds to the sensitivity indicating how much the perturbation of optical input parameters in each voxel contributes to the change in measurements.

Next in step S402, a light path matrix is computed for all voxels in the ROI as expressed by Equation (2).

$$\begin{matrix}[ Math . 2 ] & \\ B ( x , y , z ) = \{ \begin{matrix}1 & if J ( x , y , z ) \geq {T}_{SD} \\ 0 & otherwise\end{matrix} & ( 2 )\end{matrix}$$

Here, T_{SD} denotes a threshold determined by the noise level of the system including a pair of the optical input channel (source S) and the detection channel (detector D). In order to get the optical parameters of each voxel, change of m_{SD} has to be bigger than measurement noise, and the noise level of the system can be estimated in advance. The light path boundary is determined so that all the voxels in the light path satisfies the condition of B(x, y, z)=1.

As such, the optical input channel and the detection channel are appropriately arranged in order for the light path of the NIR imaging to cover the ROI.

Furthermore, in order to have the measurements obtained between the optical input channel and the detection channel carry more information, we want to have the light entering via the NIR imaging interact more with body tissue to be measured within the ROI set for the ultrasound imaging by maximizing the overlapping portion between the NIR light path and the ROI while minimizing the NIR light path propagating outside of the ROI.

Here, the probe 10 according to Embodiment 1 has been designed so that light paths obtained from all combinations of optical input channels and detection channels pass through the NIR imaging ROI. Furthermore, the probe 10 has been designed so that two light paths of the NIR imaging three-dimensionally cross with each other, and/or at least portions of two light paths overlap and cross with each other. Hereinafter, the method of designing the probe will be described.

The first step is to put an optical input channel and a detection channel such that the line from the optical input channel to the detection channel is paralleled with the 2-dimensional (2D) ultrasound imaging plane (Here we first assume the ultrasound imaging as 2D results and later extend to the 3D case).

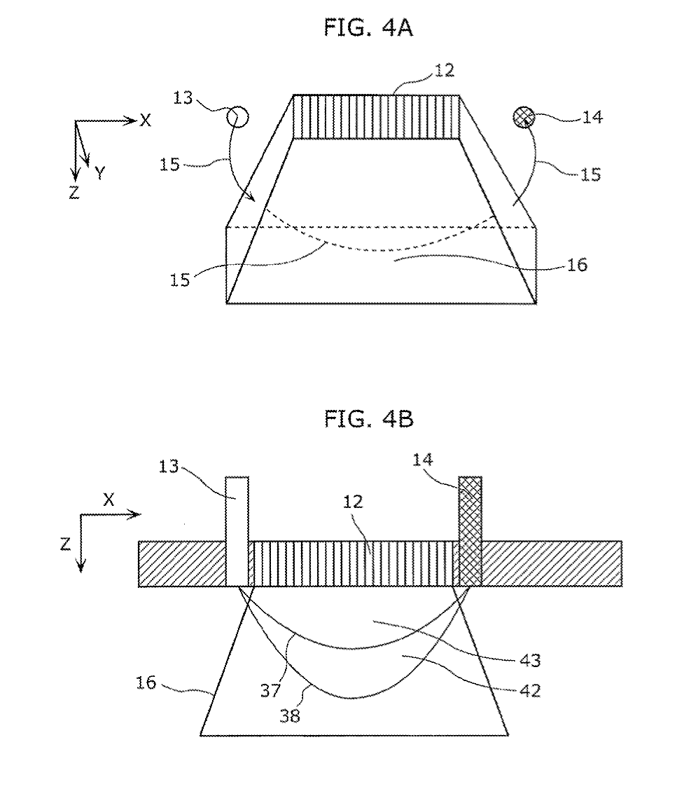

For example, when the ultrasound transducer 12 with 1-D array piezoelectric elements 81 is located in the center of the probe, one arrangement is to put the optical input channel 13 and the detection channel 14 respectively in the left area 17 and the right area 18 of the ultrasound transducer 12 along the longer axis (X axis) direction of the ultrasound transducer 12, as shown in FIG. 2A. FIG. 4A illustrates relationship between a most probable light path 15 and an ROI 16, in the arrangement of FIG. 2A.

As illustrated in FIG. 2A and FIG. 4A, when the optical input channel 13 and the detection channel 14 are arranged, it can be seen that the line from the optical input channel 13 to the detection channel 14 is paralleled with the ultrasound imaging plane (X-Z plane). Furthermore, in this case, the large portion of the most probable light path 15 is covered by the ROI 16 set for the ultrasound imaging.

On the other hand, when the optical input channel 13 and the detection channel 14 are arranged respectively in the upper area 19 and the lower area 20 with the same separation as illustrated in FIGS. 2A and 4A, the line from the optical input channel 13 to the detection channel 14 would cross the ultrasound imaging plane (X-Z plane) and the light path is less covered by the ROI 16.

In practice, an angle between the line from the optical input channel 13 to the detection channel 14 and the ultrasound imaging plane is set small in accordance with each Embodiment. For example, in FIG. 2A, the centers of the optical input channel 13 and the detection channel 14 are arranged within the left area 17 and the right area 18, respectively.

However, the light path by the arrangement in FIGS. 2A and 4A only covers a small portion of the ultrasound ROI. The fact that the minimum separation between the optical input channel 13 and the detection channel 14 cannot be less than the length of the ultrasound transducer 12 in the X axis direction limits the area covering the light path by the ultrasound imaging ROI.

From the cross-sectional view of the banana-shape light path shown in FIG. 4B, it can be seen that only an area 42 enclosed by boundaries 37 and 38 of the banana-shape light path is covered by the ultrasound imaging ROI. FIG. 4B is the cross-sectional view illustrating the relationship between the ROI and the light path in the arrangement of the optical input channel 13 and the detection channel 14 in FIGS. 2A and 4A.

In order to cover a larger area of the ROI by the light path of the NIR imaging, it is preferred that more optical input channels and detection channels are arranged.

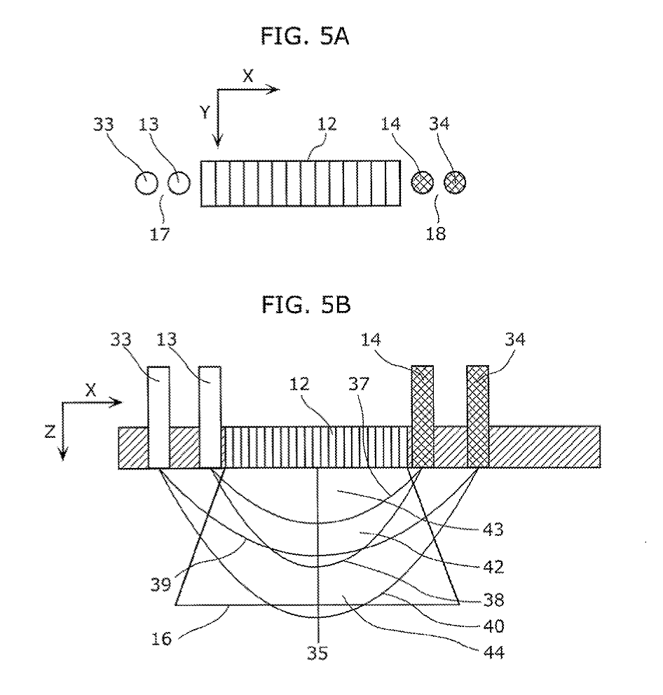

Thus, as illustrated in FIG. 5A, one more optical input channel 33 and one more detection channel 34 with larger separation are arranged in the left area 17 and the right area 18 of the ultrasound transducer 12, respectively. FIG. 5A illustrates the arrangement of the second input channel and the second detection channel in the probe of FIG. 1A. In FIG. 5A, the first input channel and the first detection channel arranged in the upper area 19 and the lower area 20 as in FIG. 1A are omitted. FIG. 5B is the cross-sectional view illustrating the relationship between the ROI and the light path in the arrangement of the second input channel and the second detection channel in FIG. 5A.

As shown in FIG. 5A, the optical input channels 13 and 33 and the detection channels 14 and 34 are arranged in one line. Furthermore as shown in FIG. 5B, the interval of the two optical input channels 13 and 33 is the same as the interval of the two detection channels 14 and 34, which is determined such that a center line 35 of the ROI 16 is continuously covered by two light paths while maximizing the light path coverage by one of the two light paths in the ROI 16.

Preferably in FIG. 5B, the separation between the optical input channel 33 and the detection channel 34 that are additionally arranged outside should be sized such that the probe body 11 is not too big for practical use.

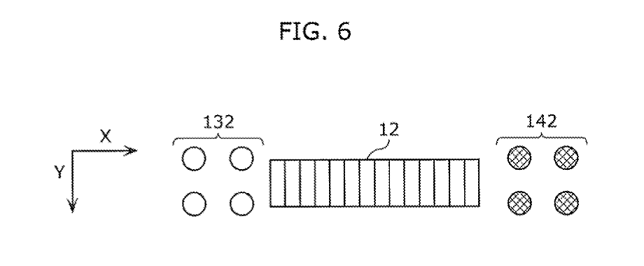

Besides the arrangement in FIG. 5A, we can also arrange the second input channel 132 and the second detection channel 142 in a plurality of lines along the Y axis direction as shown in FIG. 6 to cover a wider area of the ROI in the Y axis direction.

When an optical input channel and a detection channel are arranged in the left area 17 and the right area 18, there are cases where a shallow area 43 cannot be covered by the light paths as illustrated in FIG. 5B. Moreover, the space on the left area 17 and the right area 18 is quite limited. Thus, the ill-posed inverse problem requires more measurements to reconstruct an image.

The second step is to put at least an optical input channel and a detection channel such that the line from the optical input channel to the detection channel crosses the 2D ultrasound imaging plane.

The arrangement can be made by putting the first input channel 131 and the first detection channel 141 in the upper area 19 and the lower area 20 of the ultrasound transducer 12.

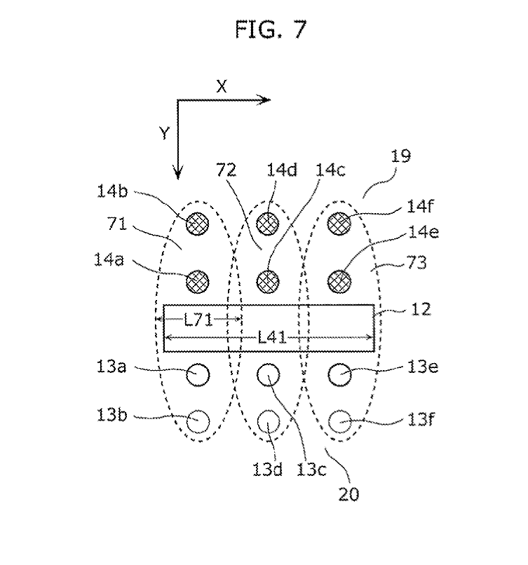

Similar to the case of putting the optical input channels and the detection channels on the left and right sides of the, ultrasound transducer 12, two optical input channels 13a and 13b and two detection channels 14a and 14b are, for example, arranged in one line as shown in FIG. 7. The two optical input channels 13a and 13b and the two detection channels 14a and 14b form a banana-shape light path 71 as indicated by a dotted line in FIG. 7.

However, just one line of two optical input channels and two as detection channels along the Y axis direction is not enough to cover the whole shallow area with respect to the surface of body tissue as the ultrasound transducer 12 has a length L12 much larger than the width of the banana-shape light path 71 (distance in the X axis direction).

Thus, additional lines of optical input channels and detection channels arranged linearly along the Y axis direction are preferably provided. According to Embodiment 1, three lines of optical input channels and detection channels are arranged parallel to the X axis direction, by adding a center line including two optical input channels 13c and 13d and two detection channels 14c and 14d and a right line including two optical input channels 13e and 1.3f and two detection channels 14e and 14f, to the left line including the two optical input channels 13a and 13b and the two detection channels 14a and 14b. Here, a banana-shape light path 72 indicated by a dotted line in FIG. 7 is formed from the optical input channels 13c and 13d and the detection channels 14c and 14d, and a banana-shape light path 73 indicated by a dotted line in FIG. 7 is formed from the optical input channels 13e and 13f and the detection channels 14e and 14f.

The minimum number K of paralleled lines is computed by Equation (3).

$$\begin{matrix}[ Math . 3 ] & \\ K = ceil ( \frac{{l}_{41}}{{l}_{71}} ) & ( 3 )\end{matrix}$$

Here, ceil(x) denotes a ceiling function to the minimum integer no less than x, l₄₁ denotes a length 41 of the ultrasound transducer 12, and l₇₁ denotes a length (width) 71 of one line of a banana-shape light path in the X axis direction.

In FIG. 7, a total of three lines each containing two optical input channels and two detection channels are used. The lines are aligned evenly, and the banana-shape light paths of neighboring lines (71 and 72, 72 and 73) have small overlaps.

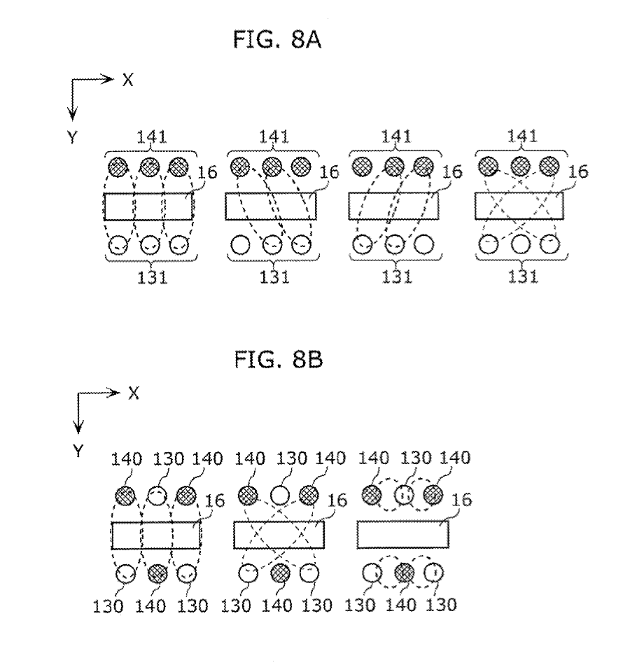

It should be noted that in order to have more useful measurements using new lines, new optical input channels are arranged in the same side as the optical input channels previously arranged, and new detection channels are arranged in the same side as the detection channels previously arranged. In other words, when optical input channels and detection channels are provided, either only the optical input channels or the detection channels are preferably arranged in each of the left area 17, the right area 18, the upper area 19, the lower area 20, the upper right area 45, the lower right area 46, the lower left area 47, and the upper left area 48, without mixing the optical input channels and the detection channels in the arrangement. This point will be described with reference to FIGS. 8A and 8B. FIG. 8A illustrates all light paths when only the first input channels 131 are arranged in the lower areas and only the first detection channels 141 are arranged in the upper areas. Furthermore, FIG. 8B illustrates all light paths when one optical input channel 130 and two detection channels 140 are arranged in the upper area and two optical input channels 130 and one detection channel 140 are arranged in the lower area.

It is found that the number of light paths that pass through the ROI 16 in the arrangement in which either the optical input channels or the detection channels are collectively arranged in the same area as in FIG. 8A is larger than the number of light paths that pass through the ROI 16 in the arrangement in which the optical input channels or the detection channels are mixed in the same area as in FIG. 8B. In other words, the arrangement of FIG. 8A shows that the light paths of all pairs of the optical input channels 131 and the detection channels 141 pass through the ROI 16. In contrast, the arrangement of FIG. 8B shows that the number of light paths that pass through the ROI 16 decreases, and that some of the light paths do not pass through the ROI 16 thus they are useless.

Thus, when optical input channels and detection channels are arranged in lines, preferably, either the optical input channels or the detection channels are collectively arranged in the same area. Thereby, the number of useless light paths can be reduced, and the wider ROI can be covered.

Although FIGS. 8A and 8B illustrate the arrangement in the upper and lower areas, such a method of arranging the optical input channels and the detection channels is also applicable for arrangement in other areas.

When adding new optical input channels and detection channels to the probe, the paths from the new optical input channels and the new detection channels to all previous optical input channels and detection channels should preferably be considered to maximize the light path coverage of the ROI. The case where a plurality of lines of the optical input channels and the detection channels are arranged in the second step can also be applied in the first step.

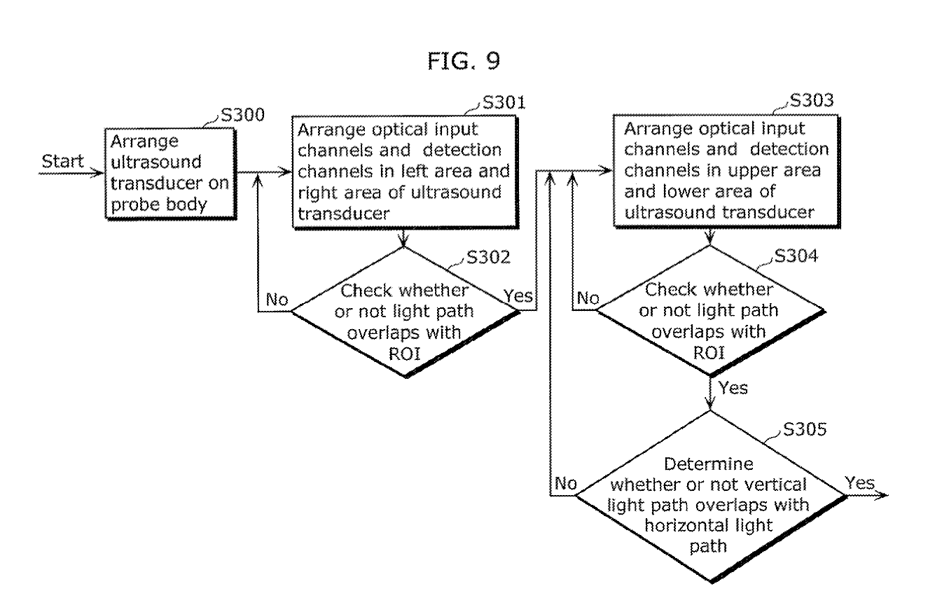

Next, the procedure for designing the probe according to Embodiment 1, that is, the layout design of optical input channels and detection channels will be described using FIG. 9 with reference to FIG. 1A. FIG. 9 is a flowchart indicating the main procedure for designing the probe according to Embodiment 1 in the present invention.

First, as in FIG. 9, an ultrasound transducer is arranged in a predestined position of a probe body (S300).

Next, the second input channel 132 including one or more optical input channels and the second detection channel 142 including one or more detection channels are arranged in the left area 17 and the right area 18 of the ultrasound transducer 12, respectively (S301).

Next, each of light paths from the second input channel 132 arranged in one of the left area 17 and the right area 18 to the second detection channel 142 arranged in the other one of the left area 17 and the right area 18 is checked, and whether or not an overlap degree between at least one of the light paths and the ROI is not smaller than a first threshold is checked (S302).

As a result of the checking, when the overlap degree is smaller than the first threshold, the processing goes back to S301, and when the overlap degree is not smaller than the first threshold, the processing goes to the next step.

Next, the first input channel 131 including one or more optical input channels and the first detection channel 141 including one or more detection channels are arranged in the upper area 19 and the lower area 20 of the ultrasound transducer 12 (S303).

Next, each of light paths from the first input channel 131 arranged in one of the upper area 19 and the lower area 20 to the first detection channel 141 arranged in the other one of the upper area 19 and the lower area 20 is checked, and whether or not an overlap degree between at least one of the light paths and the ROI is not smaller than a second threshold is checked (S304).

As a result of the checking, when the overlap degree is smaller than the second threshold, the processing goes back to S303, and when the overlap degree is not smaller than the second threshold, the processing goes to the next step.

Next, it is determined whether an overlap degree between (i) a vertical light path from one of the first input channel 131 and the first detection channel 141 arranged in the upper area 19 to the other one of the first input channel 131 and the first detection channel 141 arranged in the lower area 20 and (ii) a horizontal light path from one of the second input channel 132 and the second detection channel 142 arranged in the left area 17 to the other one of the second input channel 132 and the second detection channel 142 arranged in the right area 18 is not smaller than a third threshold (S305).

As a result of the determining, when the vertical light path does not overlap with the horizontal light path with not smaller than the third threshold (overlaps with smaller than third threshold), the processing goes back to S304. Furthermore, when the vertical light path overlaps with the horizontal light path with not smaller than the third threshold, the designing ends.

Next, the method of designing the probe will be more specifically described with reference to FIGS. 1 and 9.

In step 300, the ultrasound transducer 12 with either 1D or 2D array piezoelectric elements 81 is arranged on the center of the probe body 11. The type and the size of the ultrasound transducer 12 as well as whether the ultrasound imaging area is 2D or 3D need to be taken into consideration. When the 1D array piezoelectric elements 81 are arranged in the X axis direction, the imaging plane is defined as an x-z plane, where the Z axis represents the depth, and the X axis represents the axis along which the piezoelectric elements 81 are arranged. For the 3D ultrasound imaging, the piezoelectric elements are two-dimensionally arranged. Here, the X axis is defined as the longer one of the ultrasound transducers or either one if the lengths in the X axis direction and the Y axis direction are equal. When the piezoelectric elements 81 are two-dimensionally arranged for the 3D ultrasound imaging, the X axis is defined so that the imaging plane is equal to the x-z plane. Here, the Z axis represents the depth. Then, the surrounding area of the ultrasound transducer 12 can be defined as the area shown in FIG. 1A.

In step 301, the second input channel 132 including one or more optical input channels and the second detection channel 142 including one or more detection channels are arranged in the left area 17 and the right area 18 of the ultrasound transducer 12. Preferably, one or more of lines each including the same number of optical input channels and detection channels are arranged, in the arrangement when the second input channel 132 includes optical input channels and the second detection channel 142 includes detection channels.

When input channels and/or detection channels are arranged in each line, the interval between the optical input channels and detection channels is determined such that the overlapping of the light paths from two neighboring optical input channels and/or detection channels in one of neighboring lines to the optical input channels and/or detection channels in the other line is lower than a certain threshold, otherwise, the measurements from the two optical input channels and/or detection channels in one of the neighboring lines to the optical input channels and/or detection channels in the other line have too much redundancy.

Moreover, the interval is also determined such that the discontinuity along the center line 35 in the x-z plane is smaller than a certain threshold. Here, the discontinuity represents that none of the light paths covers the ROI.

Furthermore, the light path covered by two neighboring lines, if any, should have a small overlap to ensure that the light paths cover the ROI continuously. The minimum number of lines necessary to cover the width in the Y axis direction of the ultrasound imaging ROI can be computed similar to that for the X axis direction by Equation (3). For a 2D array transducer with 3D ultrasound imaging, multiple lines are often needed.

After the second input channel 132 and the second detection channel 142 are arranged in the left area 17 and the right area 18 of the ultrasound transducer 12, in the step 302, each light path from the second input channel 132 to the second detection channel 142 is checked to see if the overlap degree between the light path and an ultrasound ROI having the predetermined high priority is not larger than the certain first threshold.

Whether or not the light path overlaps with a predetermined ROI is determined according to Equation (2). When this condition is not satisfied, back to Step S301, the optical input channels of the second input channel 132 and the detection channels of the second detection channel 142 are re-arranged until the condition is satisfied.

In step S303, the first input channel 131 including one or more optical input channels and the first detection channel 141 including one or more detection channels are arranged in the upper area 19 and the lower area 20 of the ultrasound transducer 12. The way of the arrangement is similar to that in step S301. Furthermore, when the first input channel 131 includes optical input channels and the first detection channel 141 includes detection channels, the number of lines necessary to cover the ROI is computed by Equation (3).

Step S304 is the same as Step S302, and it would check each light path from the first input channel 131 to the first detection channel 141 each arranged in Step S303 to see if the overlap degree between the light path and the ultrasound ROI is not smaller than a predetermined second threshold.

In addition, further criteria can be added. For example, it is possible to add the condition such that the number of the light paths that do not overlap with the ROI is below a certain ratio.

When the length of the ultrasound transducer 12 in the Y axis direction is smaller than that of the X axis direction, especially it is often true for a 1-D ultrasound transducer, the arrangement of the optical input channels and detection channels in the upper area 19 and the lower area 20 of the ultrasound transducer 12 is more suitable for imaging shallow area than the arrangement of the optical input channels and detection channels in the left area 17 and the right area 18 of the ultrasound transducer 12. This is because the depth of a light path gets deeper as the distance between an optical input channel and a detection channel gets longer.

In such a case, it is possible to define that the imaging area for the first input channel 131 and the first detection channel 141 arranged in the upper area 19 and the lower area 20 of the ultrasound transducer 12 has to overlap with at least the shallow area of the ROI, and that the imaging area for the second input channel 132 and the second detection channel 142 arranged in the left area 17 and the right area 18 of the ultrasound transducer 12 has to overlap at least with the deeper area of the ROI. Here, the shallow area and the deeper area are pre-defined and the both areas can overlap with each other.

Step S305 is for determining whether or not the vertical light path from the first input channel 131 to the first detection channel 141 that are arranged in the upper area 19 and the lower area 20 overlap with the horizontal light path from the second input channel 132 to the second detection channel 142 that are arranged in the left area 17 and the right area 18.

It is preferred to have both of the light paths overlap and cross. With the overlapping and crossing of the light paths, it is possible to obtain information from two directions per voxel, and to improve accuracy of position and others of optical parameters in each voxel as a result of image reconstruction. This means that as the crossing of the light paths increases, the number of independent information carried in the Jacobi matrix increases. In this sense, it is also fine to determine the arrangement so that certain criteria, such as the number of singular vectors of the Jacobi matrix, etc., exceed the predefined threshold. Furthermore, it is preferred that the overlapping portions of both of the light paths are approximately orthogonal to each other. Thereby, the accuracy when determining the distribution of optical parameters such as absorption coefficients can be further improved in the image reconstruction.

It should be noted that the sequence of the above arrangement steps is neither important nor limited to those in Embodiment 1. It is preferred to arrange optical input channels and detection channels at least in one of (i) upper and lower areas and left and right areas and (ii) the upper and lower areas and lower and the diagonal areas, with respect to the ultrasound transducer 12. Furthermore, it is also possible to use part of the steps in FIG. 9.

In the probe 10 according to Embodiment 1 in the present invention, light paths (channel pairs) of optical input channels and detection channels cover most of the ROI. Furthermore, the optical input channels and detection channels are arranged in the probe 10 so that the number of the light paths (channel pairs) is minimized.

According to Embodiment 1, the first input channel 131 including the optical input channels is arranged in the upper area 19, the first detection channel 141 including the detection channels is arranged in the lower area 20, the second input channel 132 including one or more optical input channels is arranged in the left area 17, and the second detection channel 142 including one or more detection channels is arranged in the right area 18. Furthermore, the light paths obtained from this arrangement cover the whole area of the ROI in the planar view of the probe body 11. Furthermore, since the light paths are obtained from channel pairs of optical input channels and detection channels with different separations, different light paths are obtained in the depth direction. Thus, the different light paths in the different depth directions can cover most of the ROI in the depth direction. In addition, light paths irrelevant to the ROI hardly exists in the arrangement of the optical input channels and detection channels according to Embodiment 1.

As described above, since there is no useless optical input channel or detection channel for the ROI in the probe 10 according to Embodiment 1, it is possible to reduce the measuring time necessary for obtaining optical parameter information of body tissue and the reconstruction time necessary for reconstructing an image based on the obtained optical parameter information. Furthermore, the probe body will not be upsized.

Furthermore, optical input channels and detection channels are arranged so that light paths overlap and cross with each other in the probe 10 according to Embodiment 1. Since information can be obtained from two directions per voxel, the accuracy of image reconstruction can be improved. In addition, since the horizontal light paths are approximately orthogonal to the vertical light paths, the accuracy of image reconstruction can be further improved.

Here, additional optical input channels and detection channels can be arranged in the upper right area 45, the lower right area 46, the lower left area 47, and the upper left area 48, in addition to the left area 17, the right area 18, the upper area 19, and the lower area 20 according to Embodiment 1.

### Embodiment 2

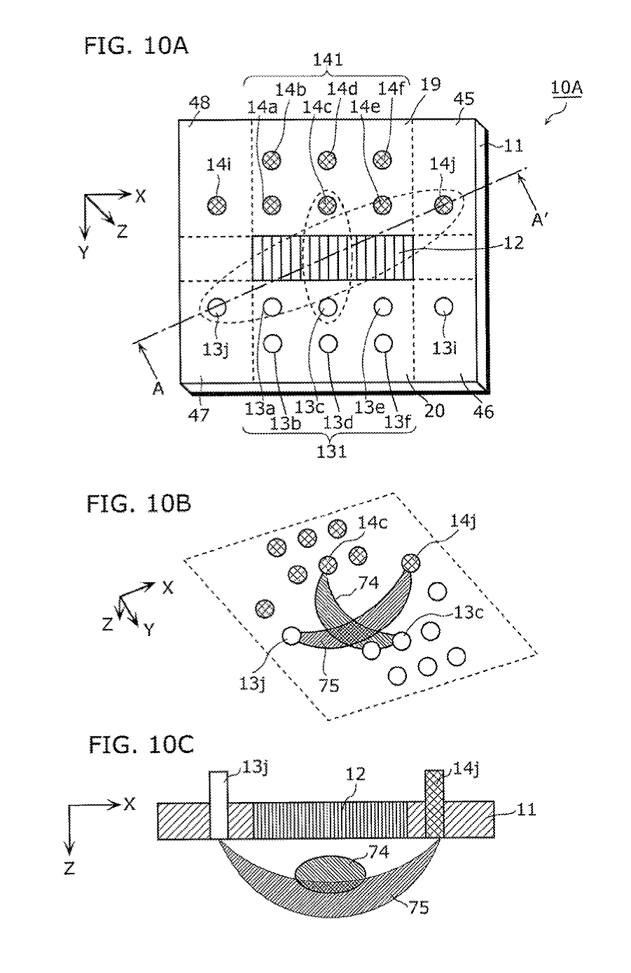

Hereinafter, a probe 10A according to Embodiment 2 in the present invention will be described with reference to FIGS. 10A to 10C. FIG. 10A illustrates an external perspective view of the probe 10A according to Embodiment 2 in the present invention. Furthermore, FIGS. 10B and 10C illustrate a state where two light paths cross with each other in the probe 10A according to Embodiment 2 in the present invention. Here, FIG. 10C illustrates a cross-section view of the probe 10A along the A-A′ line in FIG. 10A.

The probe 10A according to Embodiment 2 in the present invention has the same basic configuration as that of the probe 10 according to Embodiment 1. Thus, the same constituent elements as those in FIG. 1A are represented by the same numerals in FIGS. 10A to 10C, and the detailed description will be omitted hereinafter.

The probe 10A in FIGS. 10A to 10C according to Embodiment 2 differs from the probe 10 in FIG. 1A according to Embodiment 1 by the arrangement of optical input channels and detection channels.

In the ultrasound imaging ROI, normally, a wider and deeper area in both X and Y axes is preferably reserved. Thus, it is beneficial to put optical input channels and detection channels so that light paths from the optical input channels to detection channels cover a wider area on the X-Y plane.

Thus, as illustrated in FIG. 10A according to Embodiment 2, an optical input channel 13i and an optical input channel 13j as the second input channels are arranged respectively in the lower right area 46 and the lower left area 47, and a detection channel 14j and a detection channel 14i as the second detection channels are arranged respectively in the upper right area 45 and the upper left area 48, in the probe 10A according to Embodiment 2.

In FIG. 10A, neither optical input channel nor detection channel is arranged in the left area 17 and the right area 18. Furthermore, the first input channel 131 is arranged in the lower area 20, and the first detection channel 141 is arranged in the upper area 19, in the same arrangement as in Embodiment 1.

With the arrangement of the optical input channels and the detection channels as in FIG. 10A, a light path can be obtained in the diagonal direction of the rectangular ultrasound transducer 12. Furthermore as illustrated in FIGS. 10B and 10C, a light path 74 from the optical input channel 13c that is an example of the first input channel to the detection channel 14c that is an example of the first detection channel crosses a light path 75 from the optical input channel 13j that is an example of the second input channel to the detection channel 14j that is an example of the second detection channel so as to overlap in part.

In the probe 10A according to Embodiment 2, the diagonal light paths from the second input channels to the second detection channels arranged in the upper right area 45, the lower right area 46, the lower left area 47, and the upper left area 48 cover the surrounding and deeper area of the ultrasound transducer 12. Thus, the diagonal light paths can cover the wider and deeper area in both x and y axes.

Although one of an optical input channel and a detection channel is arranged in each of the upper right area 45, the lower right area 46, the lower left area 47, and the upper left area 48 according to Embodiment 2, the present invention is not limited to this case. For example, optical input channels or detection channels may be arranged in each of the areas.

### Embodiment 3

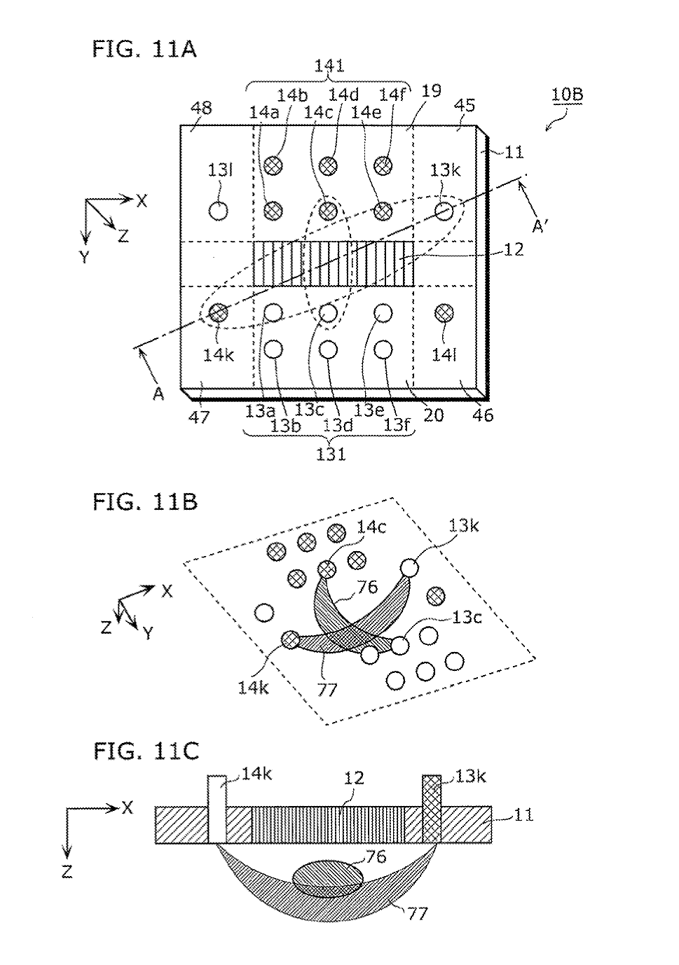

Hereinafter, a probe 10B according to Embodiment 3 in the present invention will be described with reference to FIGS. 11A to 11C. FIG. 11A illustrates an external perspective view of the probe 10B according to Embodiment 3 in the present invention. Furthermore, FIGS. 11B and 11C illustrate a state where two light paths cross with each other in the probe 10B according to Embodiment 3 in the present invention. Here, FIG. 11C illustrates a cross-section view of the probe 10B along the A-A′ line in FIG. 11A.

The probe 10B according to Embodiment 3 in the present invention has the same basic configuration as that of the probe 10 according to Embodiment 1. Thus, the same constituent elements as those in FIG. 1A are represented by the same numerals in FIGS. 11A to 11C, and the detailed description will be omitted hereinafter.

The probe 10B in FIGS. 11A to 11C according to Embodiment 3 differs from the probe 10 in FIG. 1A according to Embodiment 1 by the arrangement of optical input channels and detection channels.

Thus, as illustrated in FIG. 11A according to Embodiment 3, an optical input channel 13k and an optical input channel 13l as the second input channels are arranged respectively in the upper right area 45 and the upper left area 48, and a detection channel 14k and a detection channel 14l as the second detection channels are arranged respectively in the lower left area 47 and the lower right area 46, in the probe 10B according to Embodiment 3.

Neither optical input channel nor detection channel is arranged in the left area 17 and the right area 18 also in FIG. 11A. Furthermore, the first input channel 131 is arranged in the lower area 20, and the first detection channel 141 is arranged in the upper area 19, in the same arrangement as in Embodiment 1.

With the arrangement of the optical input channels and the detection channels as in FIG. 11A, a light path can be obtained in the diagonal direction of the rectangular ultrasound transducer 12 as in Embodiment 2. Furthermore as illustrated in FIGS. 11B and 11C, a vertical light path 76 from the optical input channel 13c that is the example of the first input channel to the detection channel 14c that is an example of the first detection channel crosses a diagonal light path from the optical input channel 13k that is an example of the second input channel to the detection channel 14k that is an example of the second detection channel so as to overlap in part.

Furthermore, the arrangement of the probe 10B according to Embodiment 3 has an advantage that the probe 10B includes a light path in an upper peripheral area from the upper right area 45 to the upper left area 48 over the upper area 19, and a light path in a lower peripheral area from the lower right area 46 to the lower left area 47 over the lower area 20.

Thereby, compared with Embodiment 2, the NIR imaging ROI can be wider in the Y axis direction. Thereby, the NIR imaging ROI can be wider than the ultrasound imaging ROI. The technique is useful when a tumor is detected by the ultrasound imaging and one wants to image the surrounding area of the tumor over the ultrasound imaging ROI, using the NIR imaging.

Although one of an optical input channel and a detection channel is arranged in each of the upper right area 45, the lower right area 46, the lower left area 47, and the upper left area 48 also according to Embodiment 3, the present invention is not limited to this case. For example, optical input channels or detection channels may be arranged in each of the areas.

### Embodiment 4

Next, a probe 10C according to Embodiment 4 in the present invention will be described.

In the probe according to each of Embodiments 1 to 3 in the present invention, the positions of the optical input channels and the detection channels are fixed. In contrast, in the probe 10c according to Embodiment 4 in the present invention, positions of optical input channels and detection channels can be adjusted.

When a tumor is located in a deeper area, it is preferred that measurements that cover the deeper area are obtained and the tumor area is imaged with a finer resolution. In order to obtain the measurements that cover the deeper area, recall the property of light paths, the optical input channels and the detection channels need larger separations. In this case, measurements of the deeper area can be obtained with the larger number of optical input channels and detection channels arranged in the left area 17 and the right area 18 in FIG. 1A. Alternatively, measurements of the deeper area can be obtained with the larger number of optical input channels and detection channels arranged in the upper area 19 and the lower area 20.

However, simply increasing the number of optical input channels and detection channels may increase the cost rapidly as well as the measuring time and the reconstruction time, also the size of the probe gets bigger, and the usability of the probe decreases.

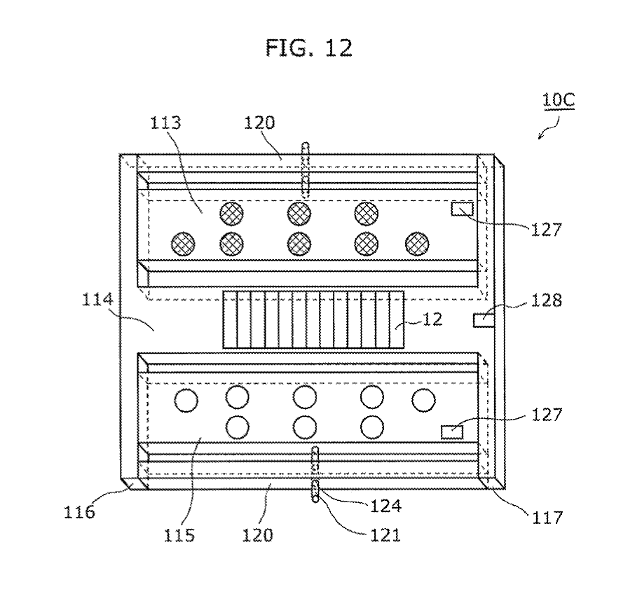

Accordingly, in the probe 10C according to Embodiment 4, optical input channels or detection channels in the upper area of the ultrasound transducer 12 and optical input channels or detection channels in the lower area of the ultrasound transducer 12 are arranged to be movable in the vertical direction (Y axis direction). The probe 10C according to Embodiment 4 that is partially movable is illustrated in FIG. 12. FIG. 12 illustrates an external perspective view of the probe 10C according to Embodiment 4 in the present invention.

As illustrated in FIG. 12, the probe 10C according to Embodiment 4 in the present invention includes a fixed part 114, a top movable part 113, and a bottom movable part 115. The fixed part 114 includes the ultrasound transducer 12. The top movable part 113 and the bottom movable part 115 are movable. The top movable part 113 and the bottom movable part 115 are provided in the upper part and the lower part of the fixed part 114, respectively. The distance between the top movable part 113 and the bottom movable part 115 can be changed by sliding the top movable part 113 and the bottom movable part 115.

The arrangement of the optical input channels and detection channels in the probe 10C in FIG. 12 according to Embodiment 4 is the same as that of the probe 10A in FIG. 10A according to Embodiment 2. In other words, in the probe 10C according to Embodiment 4, the optical input channels are arranged in the lower part corresponding to the lower area 20, the lower right area 46, and the lower left area 47 in FIG. 10A, and the detection channels are arranged in the upper part corresponding to the upper area 19, the upper right area 45, and the upper left area 48 in FIG. 10A. Thus, in the probe 10C according to Embodiment 4, detection channels are arranged in the top movable part 113 corresponding to the upper part, and optical input channels are arranged in the bottom movable part 115 corresponding to the lower part.

The two of the top movable part 113 and the bottom movable part 115 can move independently. At least one of the movable part 113 and the bottom movable part 115 is moved, so that the separations between the optical input channels arranged in the movable part 115 and the detection channels arranged in the top movable part 113 can be changed.

Furthermore, preferably, the two of the movable part 113 and the bottom movable part 115 are moved simultaneously in different directions, either upward or downward. When a deeper tumor or others is imaged, the two of the movable part 113 and the bottom movable part 115 have only to be moved away. When a shallower tumor or others is imaged, the two of the movable part 113 and the bottom movable part 115 have only to be moved closer. The amount of the movement of the movable part 113 and the bottom movable part 115 may be determined by the depth of tissue to be imaged, such as a tumor. Furthermore, the movable range of the movable part 113 and the bottom movable part 115 is determined such that the separations between the optical input channels and the detection channels are not too large to make the measurements too weak to measure.

Furthermore, the probe 10C according to Embodiment 4 further includes location sensors 127. Furthermore, each of the movable part 113 and the bottom movable part 115 includes one of the location sensors 127. Furthermore, each of the location sensors 127 monitors the movement of one of the top movable part 113 and the bottom movable part 115 with respect to a sensor 128 installed on any place in the fixed part 114. Furthermore, the location sensors 127 and 128 record the movements of the top movable part 113 and the bottom movable part 115 from the fixed part 114.

Here, holders 120 are provided at the top end and the bottom end of the fixed part 114. Furthermore, a tunable structure 121 is installed through the holders 120 to adjust the positions of the top movable part 113 and the bottom movable part 115. The top movable part 113 and the bottom movable part 115 can be manually or automatically moved by adjusting the tunable structure 121 using a motor controller (not shown). The top movable part 113 and the bottom movable part 115 may be moved by setting the distance between the optical input channels and the detection channels according to the depth of an area desirably to be imaged. In this case, depth of light paths can be changed by changing the angle of light incident from optical input channels and/or the detection channels to be described later.

Furthermore, the movement distance of the top movable part 113 or the bottom movable part 115 may be calculated and determined according to the area of the ROI as necessary, or may be determined by reading known information based on a table stored in a memory included in an information processor or others.

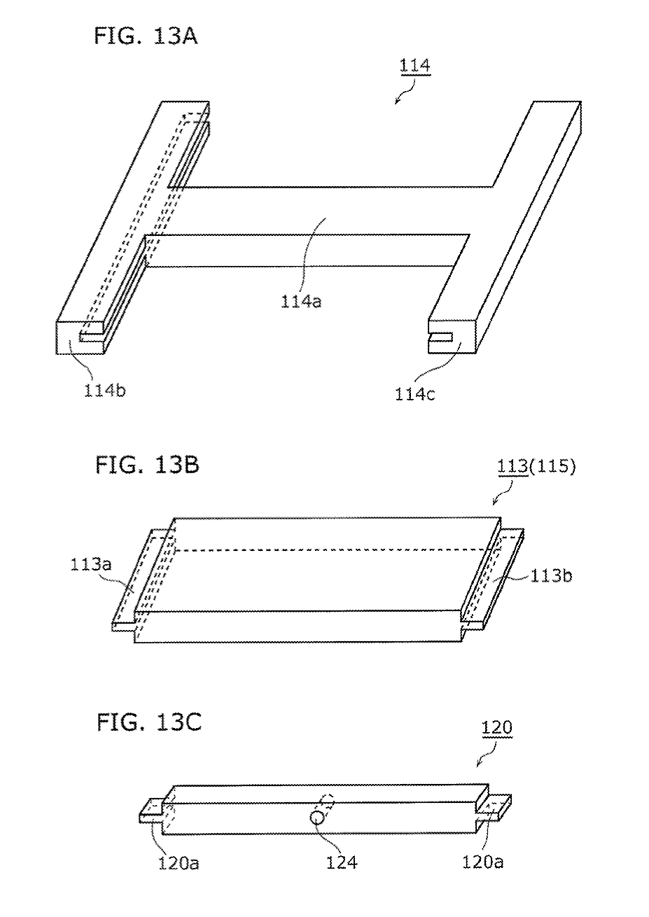

Next, each of the fixed part 114, the top movable part 113, the bottom movable part 115, and the holders 120 in the probe 10C according to Embodiment 4 will be described with reference to FIGS. 13A to 13C in detail. FIG. 13A illustrates an external perspective view of the probe 10C according to Embodiment 4 in the present invention. FIG. 13B illustrates an external perspective view of the top movable part 113 or the bottom movable part 115 of the probe 10C according to Embodiment 4 in the present invention. FIG. 13C illustrates an external perspective view of one of the holders 120 of the probe 10C according to Embodiment 4 in the present invention.

As illustrated in FIG. 13A, the fixed part 114 includes a center part 114a in which the ultrasound transducer 12 is placed, and two arms 114b and 114c connected to the ends of the center part 114a. The two arms 114b and 114c have a structure to hold the top movable part 113 and the bottom movable part 115. In order to hold the top movable part 113 and the bottom movable part 115 according to Embodiment 4, concave grooves (guides) are formed in the two arms 114b and 114c to have convex portions at the ends of the top movable part 113 and the bottom movable part 115 inserted. Here, the concave grooves have convex portions of the holders 120 inserted.

As illustrated in FIG. 13B, the top movable part 113 is a plate-like component on which optical input channels or detection channels are arranged, and convex portions 113a and 113b are formed at both ends of the top movable part 113 to be inserted into the concave grooves of the two arms 114b and 114c of the fixed part 114. Since the bottom movable part 115 has the same configuration as that of the top movable part 113 in FIG. 13B, the detailed description of the bottom movable part 115 will be omitted hereinafter.

As illustrated in FIG. 13C, the holders 120 are bar-like components at both ends of which convex portions 120a and 120b are formed to be inserted into the concave grooves of the two arms 114b and 114c of the fixed part 114. Furthermore, a through hole 124 for passing through the tunable structure 121 is formed in each of the holders 120. Each of the holders 120 is fixed between the two arms 114b and 114c of the fixed part 114.

As described above, since the probe 10C according to Embodiment 4 can change the positions of optical input channels and/or detection channels, the separations therebetween can be adjusted so that the light paths of the NIR imaging cover the ultrasound imaging ROI. As the separations between optical input channels and detection channels increase, the depth of the most probable light path increases, which can provide deeper imaging depth. Furthermore, adjustable separations between optical input channels and detection channels make it possible to focus on different depths without introducing additional optical input channels and detection channels. Thus, it is possible to perform desired NIR imaging on an area to be desirably imaged (observation area).

Since a light path can be adjusted according to an observation area in Embodiment 4, the observation area can be enlarged while suppressing the increase in the area of the probe. Furthermore, when the observation area is a deep area in tissue, a movable part has only to be adjusted so that the distances between the optical input channels and detection channels increase. In addition, when the observation area is a shallow area in tissue, a movable part has only to be adjusted so that the distances between the optical input channels and detection channels decrease.

Furthermore, since the positions of the optical input channels and/or the detection channels are movable, the positions can be fine-tuned in imaging to achieve appropriate separations between the optical input channels and detection channels.

### Embodiment 5

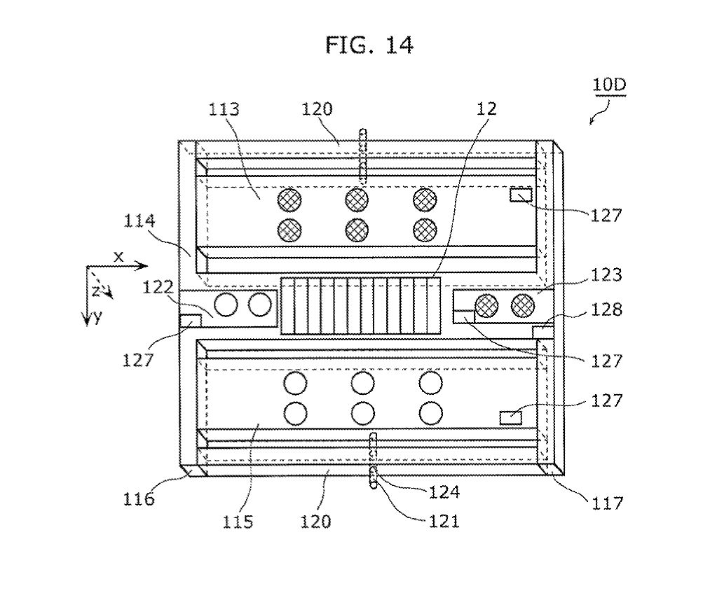

Hereinafter, a probe 10D according to Embodiment 5 in the present invention will be described with reference to FIG. 14. FIG. 14 illustrates an external perspective view of the probe 10D according to Embodiment 5 in the present invention.

The probe 10D according to Embodiment 5 in the present invention has the same basic configuration as that of the probe 10C according to Embodiment 4. Thus, the same constituent elements as those in FIGS. 12 and 13A to 13C are represented by the same numerals as in FIG. 14, and the detailed description will be omitted hereinafter.

The probe 10D in FIG. 14 according to Embodiment 5 differs from the probe 10C in FIG. 12 and others according to Embodiment 4 by the arrangement of optical input channels and detection channels.

The arrangement of the optical input channels and the detection channels in the probe 10D in FIG. 14 according to Embodiment 5 is the same as that of the probe 10 in FIG. 1 according to Embodiment 1. In other words, in the probe 10D according to Embodiment 5, the optical input channels are arranged in an area corresponding to the left area 17 and the lower area 20 in FIG. 1, and the detection channels are arranged in an area corresponding to the upper area 19 and the right area 45 in FIG. 1.

Furthermore, in the probe 10D according to Embodiment 5, the detection channels are arranged in the top movable part 113 corresponding to the upper area 19, and optical input channels are arranged in the bottom movable part 115 corresponding to the lower area 20.

Furthermore, in the probe 10D according to Embodiment 5, the optical input channels and the detection channels arranged in the left area 17 and the right area 18 of the ultrasound transducer 12 move in the horizontal direction (X axis direction).

More specifically, a left movable part 122 is provided in the left area 17 of the ultrasound transducer 12, and a right movable part 123 is provided in the right area 18 of the ultrasound transducer 12. In addition, the left movable part 122 includes two optical input channels, and the right movable part 123 includes two detection channels. In addition, the left movable part 122 and the right movable part 123 are the same as the top movable part 113 and the bottom movable part 115. In other words, concave grooves are formed in the fixed part 114, and convex portions 120a and 120b are formed in the left movable part 122 and the right movable part 123 to be inserted into the concave grooves.

Here, in the probe 10D according to Embodiment 5, detection channels are arranged in the top movable part 113 corresponding to the upper part, and optical input channels are arranged in the bottom movable part 115 corresponding to the lower part as in Embodiment 4.

The probe 10D according to Embodiment 5 in the present invention has the same advantages as those of the probe 10C according to Embodiment 4. The optical input channels and/or the detection channels in the probe 10D according to Embodiment 5 in the present invention move not only in the vertical direction (Y axis direction) but also in the horizontal direction (X axis direction). Thereby, the degree of freedom for adjusting the positions and depth of light paths obtained from combinations of optical input channels and detection channels can significantly increase.

Here, the top movable part 113, the bottom movable part 115, the left movable part 122, and the right movable part 123 may be moved by setting distances between the optical input channels and the detection channels according to the depth of an image desirably to be imaged. In this case, it is preferred that the distances between the optical input channels and the detection channels are all equal. When the distances cannot be set equal due to the inconvenience, such as physical limitations of a movable distance and the shape of an observation target, the depth of light paths can be changed by changing, within a movable distance range of the movable parts, the angle of light incident from the optical input channels and/or detected by the detection channels to be described later.

Here, the configuration and the method for adjusting the top movable part 113 and the bottom movable part 115 according to Embodiment 4 are applicable to the configuration and the method for adjusting the left movable part 122 and the right movable part 123 according to Embodiment 5.

Furthermore, the probe 10D according to Embodiment 5, but not limited to, includes four movable parts of the top movable part 113, the bottom movable part 115, the left movable part 122, and the right movable part 123. The probe 10D may include only one, two, or three out of the four movable parts, and may include more than four movable parts. Here, each of the movable parts can be moved in any direction by providing each of the movable parts with rails such as concave grooves and convex portions.

Although Embodiments 4 and 5 describe the configuration in which detection channels are arranged in the top movable part 113, the present invention is not limited to this configuration. For example, the top movable part 113 may be divided into more than two movable parts.

Hereinafter, the configuration in which the top movable part 113 is divided into a first movable part and a second movable part will be described. Three detection channels 14a, 14c, and 14e are arranged in the first movable part, and three detection channels 14b, 14d, and 14f are arranged in the second movable part. Furthermore, it is preferred that the first movable part and the second movable part are separately movable. With the first movable part and the second movable part separately movable, intervals between the detection channels 14a, 14c, and 14e and between the detection channels 14b, 14d, and 14f can be appropriately changed. As a result, the width of an area where the ROI formed by the detection channels 14a, 14c, and 14e overlaps with the ROI formed by the detection channels 14b, 14d, and 14f can be appropriately adjusted. In other words, the ROI can be used differently. For example, the largest ROI can be formed using the smallest number of detection channels, and conversely, the accuracy of data can be improved by increasing the overlapping of ROI using the larger number of detection channels.

Although the example above mentions the top movable part 113, the same is true for the bottom movable part 115, the left movable part 122, and the right movable part 123, and each of the movable parts may be divided into movable parts.

When optical axes of detection channels are switched, the shape of each area in the ROI formed by a corresponding one of the detection channels is different from each other, which will be described in Embodiment 6. Thus, even when each of overlapping areas in the ROI formed by detection channels is optimally adjusted in the default setting, there is a possibility that the overlapping area does not satisfy the ideal condition after changing the optical axes of the detection channels. Thus, the interval between the first movable part and the second movable part is changed after the optical axes of the detection channels are switched, so that the overlapping areas in the ROI can be changed to a favorable state as necessary according to change in the directions of the optical axes.

### Embodiment 6

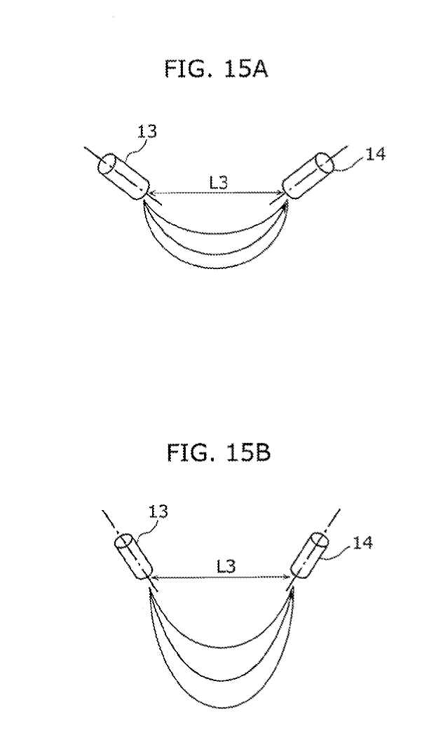

Next, a probe according to Embodiment 6 in the present invention will be described with reference to FIGS. 15A and 15B. FIGS. 15A and 15B illustrate the probe according to Embodiment 6 in the present invention.

The probe according to Embodiment 6 in the present invention basically has the same configuration as those of the probes according to Embodiments 1 to 5. In other words, the arrangement of optical input channels and detection channels in the probe according to Embodiment 6 in the present invention is the same as those of the probes according to Embodiments 1 to 5.

The probe according to Embodiment 6 differs from the probes according to Embodiments 1 to 5 in that the direction of incident light entering an optical input channel and the direction of light detected by a detection channel are switched and the optical axes of the optical input channel and the detection channel can be adjusted so as to be inclined to the measurement surface. According to Embodiments 1 to 5, the optical axes of the optical input channel and the detection channel are vertical to the measurement surface, and the direction of incident light entering the optical input channel and/or the direction of light detected by the detection channel are/is fixed.

In other words, the probe according to Embodiment 6 includes an incidence angle changing mechanism that allows, to be changed, an angle of light incident from an optical input channel 13 to an ROI, or an angle of light incident when a detection channel 14 receives light from the optical input channel 13. According to Embodiment 6, since the optical input channel 13 includes light-source fibers and the detection channel 14 includes detection fibers, the incidence angle changing mechanism has to be a mechanism to move these fibers so in as to change the optical axes of the fibers.

As illustrated in FIG. 15A according to Embodiment 6, when a shallow area of underlying tissue is imaged, that is, when the ROI is a shallow part, the incidence angle changing mechanism switches the direction of incident light entering the optical input channel 13 and the direction of light detected by the detection channel 14.

In contrast, as illustrated in FIG. 15B, when a deep area of underlying tissue is imaged, that is, when the ROI is a deep part, the incidence angle changing mechanism switches the direction of incident light entering the optical input channel 13 and the direction of light detected by the detection channel 14 so that light propagates through the deep part of the tissue.

Furthermore, it is preferred to switch the angle of light (optical axis) incident from the detection channel 14, according to the angle of light (optical axis) incident from the optical input channel 13. Thereby, the light from the optical input channel 13 can effectively enter the detection channel 14.

In the probe according to Embodiment 6, since the angles of incidence light entering an optical input channel and detected by a detection channel can be adjusted, the depth of light paths can be adjusted according to the depth of the ROI without changing the separation between the optical input channel and the detection channel.

According to Embodiment 6, although only the angles of the incidence light entering the optical input channel 13 and detected by the detection channel 14 are changed without changing the separation between the optical input channel 13 and the detection channel 14, the present invention is not limited to this case. As described in Embodiments 4 and 5, the angles of the incidence light entering the optical input channel 13 and detected by the detection channel 14 may to be changed as well as changing the separation between the optical input channel 13 and the detection channel 14 using movable parts.

Furthermore, although Embodiment 6 exemplifies the optical input channel 13 and the detection channel 14, Embodiment 6 is applicable to any optical input channel and/or any detection channel arranged in a probe body.

### Embodiment 7

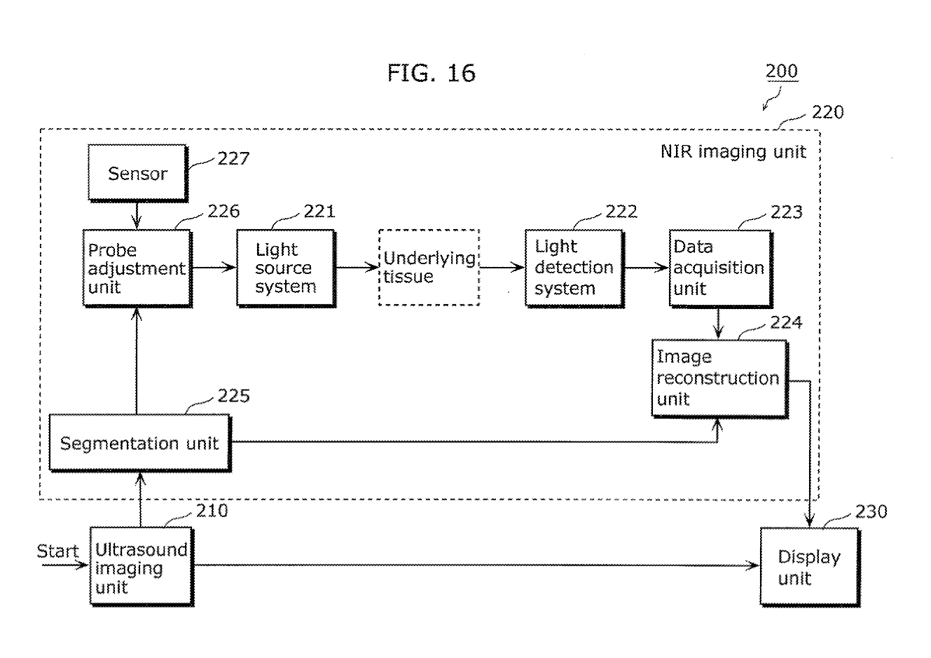

Next, an NIR imaging system according to Embodiment 7 in the present invention will be described with reference to FIG. 16. FIG. 16 is a block diagram illustrating a configuration of the NIR imaging system according to Embodiment 7 in the present invention.

As illustrated in FIG. 16, an NIR imaging system 200 mainly includes an ultrasound imaging unit 210, an NIR imaging unit 220, and a display unit 230.

In the NIR imaging system 200, the ultrasound imaging unit 210 transmits ultrasound waves to underlying tissue and receives the ultrasound echoes to form ultrasound images. The ultrasound imaging results would be used by the NIR imaging unit 220.

The NIR imaging unit 220 includes a light source system 221, a light detection system 222, a data acquisition unit 223, an image reconstruction unit 224, a segmentation unit 225, a probe adjustment unit 226, and a sensor 227.

The light source system 221 and the light detection system 222 can use the probes according to Embodiments 1 to 6. Here, the probes according to Embodiments 4 to 6 are used for adjusting the positions and angles of the incidence light of the optical input channels and the detection channels.

The light source system 221 transmits light generated by a predetermined light source to optical input channels arranged in a probe. Optical fibers can be used as transmission paths for transmitting light to the probe.

The light detection system 222 detects light using the detection channels arranged in the probe, and converts the detected light signal (detection signal) to an electrical signal for computing measurements according to the light signal.

The data acquisition unit 223 obtains the electrical signal from the light detection system 222, processes and amplifies the electrical signal, and transmits the electrical signal to the image reconstruction unit 224.

The image reconstruction unit 224 reconstructs the distribution of optical parameters of underlying tissue, based on the electrical signal transmitted from the data acquisition unit 223, and obtains an image of the underlying tissue.

When the ultrasound imaging unit 210 detects a lesion such as a tumor through the ultrasound imaging, the segmentation unit 225 segments a, portion of the lesion and computes the depth of the lesion and others. The segmentation unit 225 transmits information including the depth of the lesion to the probe adjustment unit 226.

The probe adjustment unit 226 adjusts a separation between an optical input channel and a detection channel by moving a movable part included in a probe, based on the information from the segmentation unit 225.

The sensor 227 monitors the movement of all the movable parts in the probe such that the movable parts would be accurately adjusted.

The display unit 230, for example, a display, displays a result of the NIR imaging and the ultrasound imaging.

Next, operations of the NIR imaging system according to Embodiment 7 in the present invention will be described.

First, the ultrasound imaging unit 210 transmits ultrasound waves to underlying tissue and receives the ultrasound echoes to form ultrasound images. Then, the ultrasound imaging unit 210 detects a lesion such as a tumor in the underlying tissue.

Next, the segmentation unit 225 segments a portion of the lesion and computes information including the depth of the lesion, based on the ultrasound imaging results.

The probe adjustment unit 226 adjusts a separation between an optical input channel and a detection channel by moving a movable part included in a probe and others, based on the information from the segmentation unit 225.

After the probe adjustment unit 226 finishes adjusting the probe, the light source system 221 generates light, and transmits the light to optical input channels arranged in the probe. Thereby, the optical input channels transmit the light to underlying tissue where the light gets absorbed, scattered and/or reflected.

Then, the light detection system 222 detects the light propagating through the underlying tissue, using the detection channels arranged in the probe, and converts the detected light signal to an electrical signal for computing measurements according to the light signal.

The data acquisition unit 223 obtains the electrical signal from the light detection system 222, and processes, amplifies, and/or measures the electrical signal.

Finally, the image reconstruction unit 224 reconstructs the distribution of optical parameters of the underlying tissue, based on a result of the measurements of the probe, and obtains an image of the underlying tissue. With the image reconstruction, the ultrasound imaging results can be used for computing the initial distribution of optical parameters (necessary for the image reconstruction using an iterative operation), setting the NIR imaging ROI to a tumor and the surrounding area of the tumor, or reconstructing images of the tumor and the surrounding area into higher resolution images than other images.

The images reconstructed using the NIR imaging are transmitted to the display unit 230 to be displayed together with the ultrasound imaging results. Then, the display unit 230 displays the results of the ultrasound imaging and the NIR imaging.

As described above, the images of underlying tissue can be reconstructed.

Although a probe and an image reconstruction method using the probe are described based on Embodiments, the present invention is not limited to these Embodiments.

For example, the shape of the probe is, but not limited to, a rectangle according to Embodiments. The shape of the probe may be not limited to the rectangle but other shapes, and may have a planar surface and a curved surface. Examples of the probe include a dome-shape probe which covers the entire human breast and a scanner-type probe with a curved shape which fits the curved human breast.

The probes in Embodiments can also be used to parts other than breast as long as the light can be detected. For example, tissue in brain, skin, and prostate can be imaged.

The optical detection channel (light detector) is used as, but not limited to, a detection channel in Embodiments. In other words, although the optical detection channel is used as a detection channel in Embodiments, it is possible to apply what is known as photoacoustic technique using an ultrasound detection channel as the detection channel. More specifically, laser beam is irradiated to tissue to be measured, using an optical input channel as an input channel, and an ultrasound probe measures an ultrasound signal caused by the stress and strain when the tissue absorbs light. Since the degrees of light absorption are different depending on tissue, the tissue can be assessed based on the amplitude and changes in the phase of the measured ultrasound signal (photoacoustic signal). The piezoelectric elements can be used as an ultrasound probe. Thus, the ultrasound transducer 12 for the ultrasound imaging arranged on the probe can measure the photoacoustic signal.

Without departing from the scope of the present invention, the present invention includes an embodiment with some modifications on Embodiments that are conceived by a person skilled in the art. Furthermore, the present invention may include an embodiment obtained through combinations of the constituent elements of different Embodiments in the present invention without departing from the scope of the present invention.

### INDUSTRIAL APPLICABILITY

The present invention is widely applicable as a probe using the NIR imaging, and in particular, as a probe to be used when images of tissue are reconstructed using both of the ultrasound imaging and the NIR imaging.

### REFERENCE SIGNS LIST

10, 10A, 10B, 10C, 10D Probe
11 Probe body
12 Ultrasound transducer
13, 13a, 13b, 13c, 13d, 13e, 13f, 13g, 13h, 13i, 13j, 13k, 13l, 33, 130 Optical input channel
14, 14a, 14b, 14c, 14d, 14e, 14f, 14g, 14h, 14i, 14j, 14k, 14l, 34, 140 Detection channel
15 Light path
16 ROI
16a Specific area
17 Left area
18 Right area
19 Upper area
20 Lower area
24, 26, 28, 29, 37, 38 Boundary
25, 27 Center line
35 Center line
42, 43 Area
45 Upper right area
46 Lower right area
47 Lower left area
48 Upper left area
71, 72, 73, 74, 75, 76 Light path
81 Piezoelectric elements
113 Top movable part
113a, 113b Convex portion
114 Fixed part
114a Center part
114b, 114c Arm
115 Bottom movable part
120 Holder
120a, 120b Convex portion
121 Tunable structure
122 Left movable part
123 Right movable part
124 Through hole
127 Location sensor
128, 227 Sensor
131 First input channel
132 Second input channel
141 First detection channel
142 Second detection channel
200 NIR imaging system
210 Ultrasound imaging unit
220 NIR imaging unit
221 Light source system
222 Light detection system
223 Data acquisition unit
224 Image reconstruction unit
225 Segmentation unit
226 Probe adjustment unit
230 Display unit

1-11. (canceled)

12. A probe that performs near infrared (NIR) imaging on a region of interest that is an imaging target, said probe comprising
a probe body in which input channels and detection channels are arranged,
wherein an area of the probe body corresponding to the region of interest is a specific area, and in a planar view of the probe body, areas to the left, the right, the upper, the lower, the upper right, the lower right, the lower left, and the upper left of the specific area are defined as a left area, a right area, an upper area, a lower area, an upper right area, a lower right area, a lower left area, and an upper left area, respectively, and
said probe body includes:
first input channels arranged in only one of the upper area and the lower area;
first detection channels arranged in only the other one of the upper area and the lower area;
one or more second input channels arranged in at least one of the left area, the right area, the upper right area, the lower right area, the lower left area, and the upper left area; and
one or more second detection channels arranged in an area opposite to the one of the left area, the right area, the upper right area, the lower right area, the lower left area, and the upper left area in which said second input channels are arranged with the specific area disposed in between.

13. The probe according to claim 12,
wherein each of (i) a light path from each of said first input channels to a corresponding one of said first detection channels and (ii) a light path from each of said second input channels to a corresponding one of said second detection channels overlaps with the region of interest by more than a certain degree.

14. The probe according to claim 12,
wherein said first input channels and said first detection channels are arranged in respective lines, and
each of the lines includes said first input channels and said first detection channels.

15. The probe according to claim 12,
wherein a light path from said first input channel arranged in a first line to said first detection channel arranged in a direction of the first line overlaps with a light path from said first input channel arranged in a second line adjacent to the first line to said first detection channel arranged in a direction of the second line.

16. The probe according to claim 12,
wherein first light paths from said first input channels to said first detection channels overlap and intersect with second light paths from said second input channels to said second detection channels.

17. The probe according to claim 16,
wherein the first light paths are approximately orthogonal to the second light paths.

18. The probe according to claim 12, further comprising
an ultrasound transducer in the specific area which transmits ultrasound waves and receives ultrasound echoes,
wherein the region of interest is determined based on an imaging area of said ultrasound transducer.

19. The probe according to claim 12, further comprising
a movable part that allows positions of at least one of said first input channels, said first detection channels, said second input channels, and said second detection channels to be changed.

20. The probe according to claim 12, further comprising
an incidence angle changing mechanism that allows, to be changed, an angle of light incident from one of said first input channels and said second input channels to the region of interest, or an angle of light incident when one of said first detection channels and said second detection channels receive light.

21. An image reconstruction method of acquiring optical data of tissue and reconstructing an image of the tissue by putting the probe according to claim 12 on a surface of the tissue and performing NIR imaging on the tissue, said image reconstruction method comprising:
determining a region of interest that is a target for the NIR imaging;
illuminating the region of interest by at least one input channel on the probe;
detecting, by at least one detection channel, light that is illuminated by the input channel and propagates through the tissue; and
reconstructing optical characteristics in the region of interest by using the detected light.
